(19) United States
(12) Patent Application Publication
(10) Pub. No.: US 2008/0232264 A1
(43) Pub. Date: Sep. 25, 2008

(54) System and method for simulating dynamic routing of traffic over an IP network

(76) Inventors: Yair Horovitz, Miskeret Batya (IL); Ziv Cohen, Haifa (IL); Shlomo Jacobson, Modi'in (IL); Ophir Munk, Tel-Aviv (IL); Guy Shalom, Ra'anana (IL)

Correspondence Address: Pearl Cohen Zedek Latzer, LLP, 1500 Broadway, 12th Floor, New York, NY, 10036, US

(21) Appl. No.: 11/723,823

(22) Filed: Mar. 22, 2007

(51) Int. Cl. G08C 15/00; H04J 1/16

(52) U.S. Cl. 370/252; 370/235

(57) ABSTRACT

A system and method of triggering a switch of transmission of signals from a first route of a virtual IP network to a second route of a virtual IP network upon detecting a pre-defined condition on a distant hop of the first route, and evaluating parameters of such switch from the first route to the second route.

### FIELD OF THE INVENTION

The present invention generally relates to computer network emulation. More particularly, the present invention relates to a system and method for simulating a switch of routes for transmission over IP networks when a pre-defined criterion is satisfied.

### BACKGROUND OF THE INVENTION

Traffic such as signals or data sent over an IP network may travel over various routes, paths or connections that may link one or more points connected to the IP network. One such path may be or include a regular or default path over which data or signals may be sent on a regular basis assuming that for example the network is not then overloaded or otherwise subject to adverse conditions. One or more alternate paths may also be available for the transmission of traffic, and such alternate paths may be used for transmission in the event that one or more hops on a default path is out of service, overloaded or otherwise unable to handle a particular traffic. Designating default and alternate paths, and establishing criteria upon which traffic is to divert from a default path to an alternate path typically involves prior knowledge or guesswork by a network administrator or other operator. Similarly, testing one or more scenarios upon which a connection is switched from a default route to an alternate route is done ex-post-facto rather than in advance.

### SUMMARY OF THE INVENTION

An embodiment of the invention may include a system having a memory to store data about a first route on a virtual IP network with a proximate hop and a distant hop relative to the point or node on the network which may provide a routing instruction, and about a second route on the virtual IP network. The memory may also store a pre-defined criteria or trigger which, when met, may be taken as an instruction or indication to switch a route used for transmission of signals on the virtual IP network from the first route to the second route. The system may also include a processor that may generate or detect a condition on for example a distant hop. When for example the generated or detected said condition matches, reaches or exceeds the pre-defined criteria, a switch may be made and signals may be transmitted along the second route rather than or in addition to the first route.

In some embodiments, a processor may evaluate or test the efficiency or accuracy or other functions or results of a switching from the first route to the second route. In some embodiments, a memory may store a result of the switch of routes and a display may show a chronology of the existence or growth of the condition on the hop, until the hop reaches or exceeds the criteria, and the switch from the first route to the second route is made.

In some embodiments a memory may store data about a second condition that may be generated or monitored on for example a distant hop, so that when the second condition occurs, a switch may be made back from the second route to the first route. More than one route may be used at a time.

In some embodiments a processor may evaluate the process of switching between or among the routes. For example a parameter, such as identifying the precise event or moment of triggering said switching, may be calculated to determine an accuracy of the switch to the pre-defined criteria. A parameter may also include a time of the switch from the first route to the second route, a speed of the switching from the first route to the second route, a loss of communication signals upon the switching from the first route to the second route, a sensitivity of the switching to the pre-defined criteria, a throughput on the second route, a utilization on the second route, and a performance of an application on the IP network following the switching from the first route to the second route.

In some embodiments, the condition on the distant hop that may be tested or generated may include for example a failure over time, packet loss over time, a link usage in over time for utilization, a link usage in over time for throughput, a link usage out over time for utilization, a link usage out over time for throughput, a number of packets being sent over a hop or over the first route or second route, a number of bytes being sent over a route or a number of bytes in one or more packets, a size of packets, and a content of a packet.

In some embodiments, a method may designate a first path of a virtual IP network, where the path includes at least two hops, such as a proximate hop and a distant hop, the method may detect or generate a condition on the distant hop of the first path, and may switch the transmission of signals to a second path of the virtual IP network.

In some embodiments the method may evaluate an effect of the switch on a transmission of signals on the virtual IP network. In some embodiments the method may evaluate an effect of the switching on an application running on the virtual IP network.

In some embodiments, a system may include a memory to store data about a first route on a virtual IP network, a second route on the virtual IP network, a pre-defined criteria for switching transmission of signals on the virtual IP network from the first route to the second route; and a processor to test for a condition on the first route, to determine if the condition on the first route matches a pre-defined criteria, where the condition may be for example a failure over time, packet loss over time, a link usage in over time for utilization, a link usage in over time for throughput, a link usage out over time for utilization, a link usage out over time for throughput, a number of packets, a number of bytes, a size of packets, and a content of a packet.

In some embodiments, a processor may generate a condition on said distant hop. In some embodiments the invention may be stored on an article in the form of instructions that when executed may yield results of an embodiment of the invention.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a conceptual illustration of components such as a network emulator or other system that may simulate network conditions, in accordance with a preferred embodiment of the present invention;

FIG. 2 is a conceptual illustration of a virtual network architecture, that may for example be simulated by the components of FIG. 1, in accordance with a preferred embodiment of the present invention;

FIG. 3 is a flow diagram of a method in accordance with an embodiment of the invention; and

FIG. 4 is a flow diagram of a method in accordance with an embodiment of the invention.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “evaluating,” “processing,” “computing,” “calculating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In some embodiments, the terms close or proximate and distant or far may, in addition to their standard meanings, also imply distance or relative location from a virtual device that may include or execute a rule or direction for transmission of signals on a virtual IP network. For example, a device that may include software and/or hardware that may direct a transmission of signals on the virtual IP network along one or more routes of the virtual IP network. For example, in some embodiments, a virtual IP network may include a configuration of links, hops or connections between a first node on a network and a second node on the network, such as between two or more routers or gateways or other network connections. A distant or proximate hop may refer for example to a link that is removed from a router or tool that may issue an instruction or include a rule to direct or re-direct a signal or transmission on an IP network on one or more paths or routes between for example the first node and the second node.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols, software or hardware configurations may be used to implement the teachings of the embodiments of the invention as described herein. Instructions that when executed may perform an embodiment of the invention, may in some embodiments be included or stored on an article such as for example a disc, memory or mass data storage unit. The instructions may be loaded into a processor which may execute them.

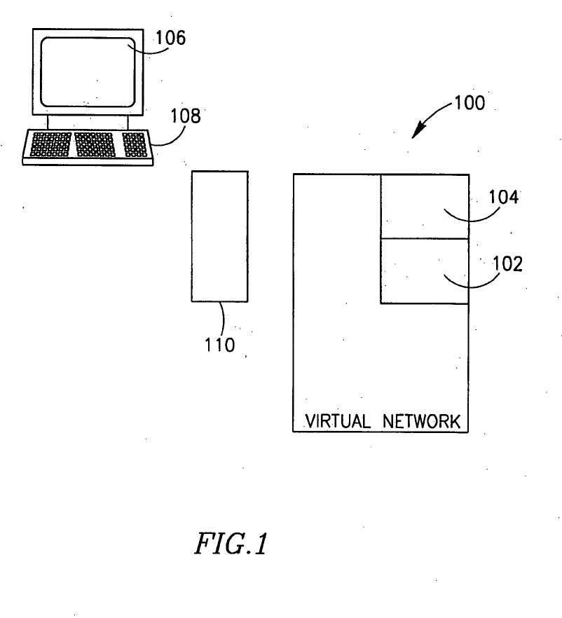

Reference is made to FIG. 1, a conceptual illustration of components such as a network emulator or other system that may simulate network conditions, in accordance with a preferred embodiment of the present invention. In some embodiments, components that may be used in emulating or simulating a network may include for example an emulator 100, such as a VE Network Appliance available from Shunra Software Ltd. of Kfar Sava, Israel. Other appliances may be used. Embodiments of the invention may be practiced without a particular appliance. Rather, an emulation of a network may in some embodiments be created by software or by a combination of hardware and software.

Emulator 100 may be or include for example a processor 104 and a memory 102. Processor 104 and memory 102 may among other functions simulate a virtual network according to a model that may for example be input by the user. Processor 104 may include one or more processors that may be housed inside or outside of emulator 100. Emulator 100 may simulate execution of one or more applications over the network, including virtual transmissions of data over a series of virtual links or virtual connections between virtual points in the virtual network, and such may be simulated on or in the presence of various conditions to which the virtual network may be subject. In some embodiments, traffic may be created by a traffic generator. In some embodiments, traffic may be generated by an application transaction generator or by an actual or real application user that is run or executed over the simulated network. Emulator 100 may in some embodiments not create the traffic.

Memory 102 may be or include for example random access memory, read only memory, flash or non-volatile memory, a disc drive, other magnetic storage medium or other mass data storage medium that may record and store data on network connections in a virtual network. Memory 102 may include one or more memory units that may be housed in or outside of emulator 100. In some embodiments, processor 104 may evaluate, calculate or determine performance metrics for data that may be transmitted over a virtual network, such as for example to or from one or more points on the virtual network. In some embodiments, a metric may include for example an average throughput rate of data transmitted to or from one or more points or users connected to a virtual network. Other metrics and other performance characteristics may be collected. Memory 102 may store for example connection constraints such as latency, utilization, bandwidth, packet loss and other characteristics of a connection or network point. In some embodiments, memory 102 may store for example an IP address of one or more points or users of a network or virtual network as well as various network connectivity constraints that may be applied to such IP addresses. In some embodiments, performance metrics, characteristics and constraints may be collected, calculated and stored by an external memory or processor.

A display 106 may display for example real time or collected representations of a structure of a virtual network and one or more constraints of points or links on such network. In some embodiments, a display may include a user interface that may allow a user or operator to add, delete, replace or alter connections on a virtual network or characteristics or constraints of such connections or points. A display may be connected to for example an input device 108 such as for example a keyboard or mouse.

In some embodiments, one or more functions of emulator 100 may be included in for example instructions such as for example software instructions that may be executed on a platform such as for example a personal computer or work station 110. In some embodiments, processor 104 and memory 102 may be included in such a platform. Some embodiments may include a separate network appliance in one or more separate units, or may combine emulator 100 into another unit or may use a software based emulator.

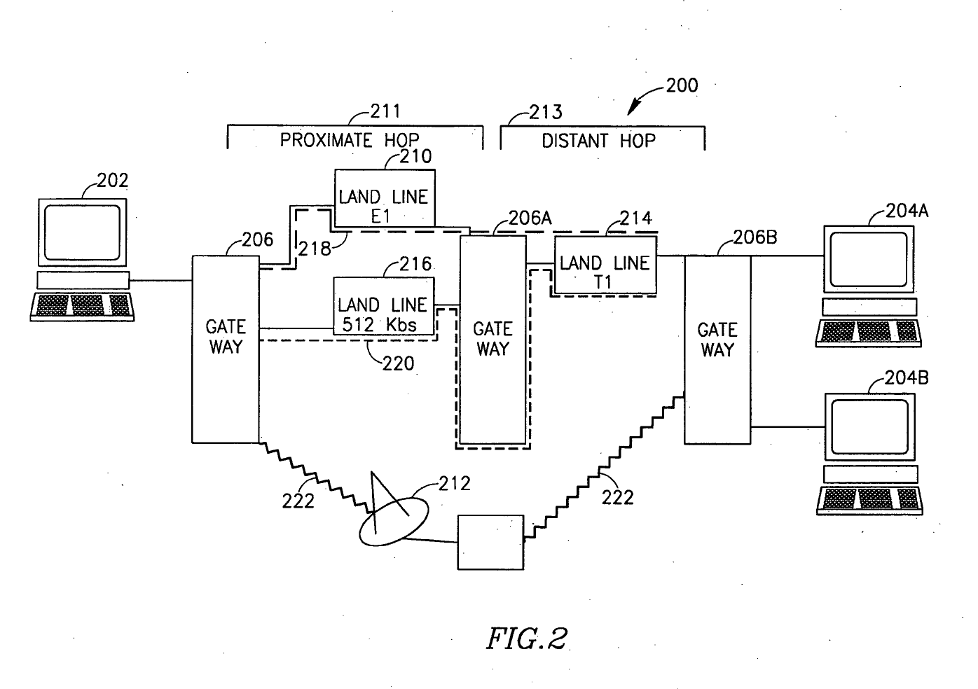

Reference is made to FIG. 2, a conceptual illustration of a virtual network architecture, that may for example be simulated by the components of FIG. 1, in accordance with a preferred embodiment of the present invention. It will be appreciated that for simplicity and clarity, elements included in a virtual network such as those that may be created by emulator 100 may be virtual rather than actual, though they may, upon a simulation, demonstrate the characteristics of an actual network. In some embodiments, a virtual IP network 200 may include one or more virtual endpoints 202, 204A and 204B. In some embodiments, such an endpoint may include one or more clients or user computers that may be connected to the virtual IP network 200 such as for example IP telephones, personal communication devices or other electronic devices that may be suitable for communicating or connecting over an IP network and over virtual IP network 200. End point 202 may be connected in the virtual network 200 to a virtual gateway 206. The characteristics of one or more of these virtual components may be assigned by for example a user of emulator 100.

In some embodiments, virtual gateway 206 may further connect data or signals to and from end point 202 to a virtual carrier of IP traffic such as an emulation of an E1 land line 210 or for example a 512 Kb/s land line 216 that may be connected to for example another gateway 206A or another router. In some embodiments, virtual gateway 206A may be connected by for example a T1 line 214 to a virtual gateway 206B. Other connections using other transmission media with other bandwidths or carrying capacities may be used. In some embodiments, satellite link 212 or another transmission media may link virtual gateway 206 with virtual gateway 206B.

In some embodiments, a link or hop between virtual gateway 206 and virtual gateway 206A may be a near or proximate hop 211, relative to the gateway 206, that may apply a rule or policy to alter a path of transmission on the IP network. Distant hop 213 may be a link or hop between virtual gateway 206A and virtual gateway 206B, as may be relatively removed from gateway 206.

In some embodiments, processor 104 of FIG. 1 or another processor may facilitate an emulation of a path or route of a virtual network 200 from endpoint 202 to for example one or more other endpoints 204A and 204B. Memory 102 of FIG. 1 or another memory may store for example one or more policies such as those that may include a pre-defined criteria, conditions or scenarios for the implementation or use of routes or paths on the virtual network 200. In some embodiments, memory 102 may include one or more policies that may call for a switch from for example a default path 218 of the virtual network 200 to an alternate path 220, or to alternate path 222 and, for example, for switching transmissions back to original default path 218 when such conditions have ended for a designated period of time or in a way that meets some other condition. In some embodiments, other components or connections, may be interposed between endpoint 202, virtual gateway 206, virtual gateway 206A, virtual gateway 206B or elsewhere in the virtual network 200.

In some embodiments, under for example normal conditions, a virtual flow of data, signals or traffic of virtual IP network 200 may flow on a typical, standard or default path 218 (shown in the figures as a dotted line next to a regular line). More than one default path 218 may be used at a time. Default path 218 may be used for some or all virtual IP network 200 transmissions until a condition occurs or pre-defined criteria is met in the emulation that may signal or be indicative of a preference or instruction to use an additional route or alternate path 220 (shown as an unbroken line with x's) over which emulated data may flow on the virtual network 200. For example, in some embodiments, a condition may arise or be created on distant hop 213 between gateway 206A and gateway 206B, and transmissions may be switched from default path 218 to alternate path 220.

In some embodiments, data describing the default path 218, alternate path 220 and some or all of the conditions or pre-defined criteria on for example proximate hop 211 or distant hop 213 or elsewhere upon which a switch is to be made in virtual IP network 200 from a virtual default path 218 to a virtual alternate path 220 or from an alternate path 220 back to a default path 218 may be stored in memory 102 and may be implemented by processor 104 or by other components. In some embodiments, more than one additional or alternate route or alternate path 220 may be used at a time. For example, a pre-defined criterion or instruction may dictate that if conditions generated on virtual network 200 such as on proximate hop 211 or distant hop 213, reach, exceed or match a first threshold, then a first additional or alternate path 220 is to be used. If a second threshold of a given condition is encountered, then another alternate path 222 (indicated by a wavy line) may be added in addition to or instead of the first alternate path 220. In some embodiments, one or more default paths 218 may be used at the same time as one or more additional or alternate paths 220. In some embodiments a default path 218 may carry traffic at the same time that an alternate path 220 carries traffic.

When an application is run over virtual IP network 200, and a pre-defined condition is encountered on a path or on a hop of a path, and an indication of such condition may be stored in memory 102, processor 104 may trigger a switch of traffic to alternate path 220. In some embodiments, during the time alternate path 220 is in use, a second or another predefined condition or criteria that may be stored in memory 102 may occur, and processor 104 or another processor may restore traffic to default route 218. In some embodiments, a minimum time for the existence of a pre-defined condition on the emulated network may be required in order to trigger a switch from a default route 218 to an alternate route 220 or back again.

In some embodiments, memory 102 in for example emulator 100 or elsewhere, may record the conditions or levels of traffic on the virtual network 200 or on proximate hop 211 or distant hop 213 that triggered a switch from default route 218 to alternate route 220. For example, processor 104 may measure the accuracy and speed of the switch in route or path that may be implemented by for example processor 104 or another measure relating to the switch from default route 218 to alternate path 220 once a condition is reached. In some embodiments, processor 104 and memory 102 may record for example the time that the generated virtual conditions reached a pre-defined criteria, and may record time elapsed from the appearance of such condition to when a route was switched from a default route 218 to an alternate path 220. Similarly, processor 104 and memory 102 may record or track the flow of transmissions or other conditions that may have triggered a pre-defined criteria for the switch to alternate path 220, and may determine the extent of signals or data that may have been lost during or prior to such switch.

In some embodiments, processor 104 and memory 102 may record and store levels or conditions of a virtual network, traffic routes, performance of one or more of the links or connections in one or more routes and an indication of one or more of the switches or detours from for example a default route 218 to an alternate path 220, or vice versa in switching back, as such switch coincided with an occurrence of conditions that may have triggered the switch. In some embodiments, processor 104 and display 106 may display an indication of a condition for triggering a switch or switching back from one route to another route, and an indication of a flow of traffic on one route and then on another route reflecting such switch. In some embodiments, such indication may be displayed graphically on for example a screen showing the chronology of meeting a pre-defined criteria, the switch from a default route 218 to an alternate path 220, or switching back from an alternate path 220 to the default route 218, the flow of traffic on alternate path 220 for the duration of the existence of the condition that triggered the switch, or the flow of traffic on default path 218 for the duration of the existence of the condition that triggered switching back.

In some embodiments, processor 104 and memory 102 or other components may evaluate and record all or some of the switch back from alternate path 220 to default route 218, the sensitivity of the switch to the change in traffic, the duration of conditions on the virtual network 200 that triggered the switch of routes, the time of the trigger and the time of the switch, losses of data or signals that may have occurred prior to such switch and that may have been caused by or as a result of the switch, or other conditions relating to the switch.

In some embodiments, a condition may be generated by another component that may be connected to the IP network 200, or the condition may be caused by one or more applications or tests that may be run on the IP network. In some embodiments, processor 104 may test for the existence of a particular condition that may be caused other than by processor 104.

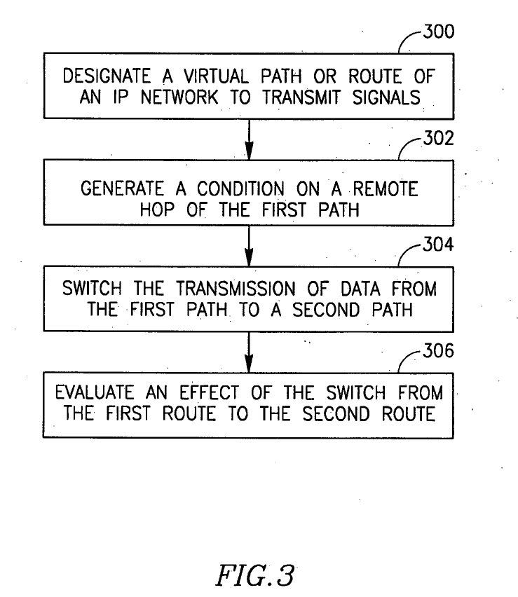

Reference is made to FIG. 3, a flow diagram of a method in accordance with an embodiment of the invention. In block 300, a processor that may for example be included in an emulator or simulation device may create, emulate or designate a virtual path or route of a virtual IP network over which signals or traffic may be transmitted. The first path may be an emulation of links or connections between components of a virtual network that may be designated within the emulator device. Such links may include a series of hops such as a proximate hop and a distant hop.

In block 302, the emulator may detect, create or generate a condition on a link such as on a proximate hop or distant hop of a first path in the virtual network. The condition may also be generated externally for example by another element creating for example an overload of traffic on the virtual network, and such condition may be detected by for example a sensor that may monitor conditions on the virtual network. The sensor may also be part of the emulation.

In block 304, a processor may, once the conditions on the first path have reached a pre-defined criteria or limit, switch the transmission of data from the first path or route to a second path of the virtual IP network.

In block 306, a processor may evaluate an effect of the switch from the first route to the second route. Such evaluation may be or include for example judging a speed of the switch of routes from a first route to a second route, a loss of data during the switch, an accuracy in measuring or responding to the conditions on the path, comparing a time of reaching a condition on a path with a time of the switch from the first path to the second path, a change in a function or for example speed or other performance of an application during or after the switch, and an effect of a manual switch or of an automated switch or other measurements.

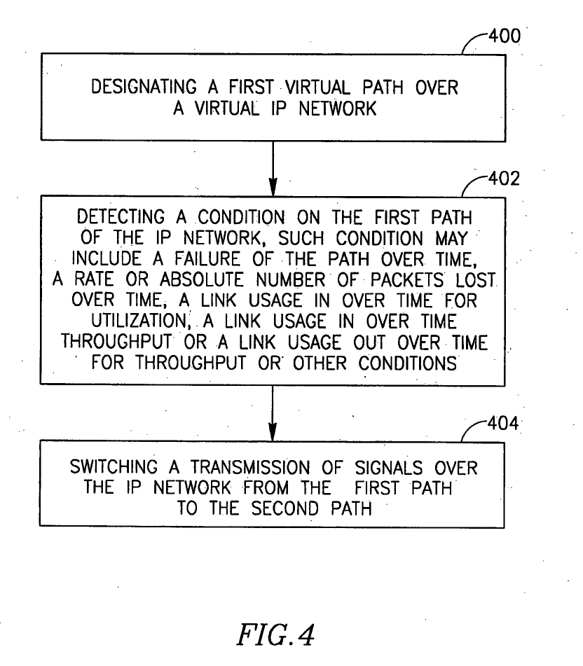

Reference is made to FIG. 4, a flow diagram of a method in accordance with an embodiment of the invention. In block 400, a processor may for example designate a first virtual path over a virtual IP network. In some embodiments, such processor may be included in for example an emulation tool.

In block 402, a processor may detect a condition on the first path of the IP network, where such condition may be or include for example a failure of the path over time, a rate or absolute number of packets lost over time, a link usage in over time for utilization, a link usage in over time for throughput or a link usage out over time for throughput or other conditions.

In block 404, a processor may switch a transmission of signals over the IP network from the first path to the second path.

In some embodiments a method may include evaluating a performance of the switch from the first route to the second route or back from the second route to the first route. Such an evaluation may include for example identifying the event that triggered the switching from the first route to the second route and comparing that event to the pre-defined criteria that was to have triggered the switch, determining a time of the switching from the first path to the second path, calculating the speed at which the switch was executed once the condition was identified on the first route or once a signal was issued to make the switch, calculating a loss of communication signals upon the switching from the first path to the second path, determining a sensitivity of the processor to the identified condition on the first path, and evaluating a performance of an application that may have been running or that may be run on the IP network at the time that the switch was made or before and after the switch was made.

It will be appreciated by persons skilled in the art that embodiments of the invention are not limited by what has been particularly shown and described hereinabove. Rather the scope of at least one embodiment of the invention is defined by the claims below.

We claim:

1. A system comprising:
a memory to store data about:
a first route on a virtual IP network said first route comprising a plurality of hops, said plurality of hops comprising a proximate hop and a distant hop;
a second route on said virtual IP network,
a pre-defined criteria for switching transmission of signals on said virtual IP network from said first route to said second route; and
a processor to generate a condition on said distant hop, said condition matching said pre-defined criteria.

2. The system as in claim 1, wherein said processor is to evaluate a switching from said first route to said second route.

3. The system as in claim 2, wherein said memory is to store a result of said evaluation, and comprising a display to show said first route, said second route, a characteristic of said condition, and a chronological display of said condition reaching said criteria and said switch from said first route to said second route.

4. The system as in claim 1, wherein said criteria comprises a first criteria, and wherein
said memory is to store a second criteria for switching transmission of signals on said virtual IP network from said second route to said first route; and
said processor is to generate a second condition, said second condition matching said second criteria.

5. The system as in claim 4, wherein said processor is to evaluate said switching from said second route to said first route upon reaching said second criteria.

6. The system as in claim 1, wherein said processor is to calculate a parameter selected from the group consisting of:
an event triggering said switching,
a time of said switching from said first route to said second route,
a speed of said switching from said first route to said second route,
a loss of communication signals upon said switching from said first route to said second route,
a sensitivity of said switching to said pre-defined criteria,
a throughput on said second route,
a utilization on said second route, and
a performance of an application on said IP network following said switching from said first route to said second route.

7. The system as in claim 1, wherein said condition on said distant hop is selected from the group consisting of:
a failure over time, packet loss over time,
a link usage in over time for utilization,
a link usage in over time for throughput,
a link usage out over time for utilization,
a link usage out over time for throughput,
a number of packets,
a number of bytes,
a size of packets, and
a content of a packet.

8. A method comprising:
designating a first path of a virtual IP network, said first path comprising at least two hops, said at least two hops comprising a proximate hop and a distant hop;
detecting a condition on said distant hop of said first path; and
switching transmission of signals to a second path of said virtual IP network.

9. The method as in claim 8, comprising evaluating an effect of said switching on a transmission of signals on said virtual IP network.

10. The method as in claim 8, comprising evaluating an effect of said switching on an application running on said virtual IP network.

11. The method as in claim 8, comprising calculating a parameter of said switching, said parameter selected from the group consisting of:
an event triggering said switching,
a time of said switching from said first route to said second route,
a speed of said switching from said first route to said second route,
a loss of communication signals upon said switching from said first route to said second route,
a sensitivity of said switching to said pre-defined criteria,
a throughput on said second route,
a utilization on said second route, and
a performance of an application on said IP network following said switching from said first route to said second route.

12. The method as in claim 8, wherein said detecting comprises detecting that said condition on said distant hop of said first path matches a pre-defined condition for a pre-defined period.

13. The method as in claim 8, wherein said detecting a condition comprises detecting a first condition on said distant hop of said first path, and comprising:
detecting a second condition; and
switching said transmission from said second path to said first path.

14. The method as in claim 13, comprising evaluating an effect of said switching from said second path to said first path, said effect on said transmission of signals on said virtual IP network.

15. The method as in claim 8, wherein said condition on said distant hop is selected from the group consisting of:
a failure over time, packet loss over time,
a link usage in over time for utilization,
a link usage in over time for throughput,
a link usage out over time for utilization,
a link usage out over time for throughput,
a number of packets,
a number of bytes,
a size of packets, and
a content of a packet.

16. An article comprising instructions stored thereon that when executed result in:
designating a first path of a virtual IP network for transmission of signals, said first path comprising at least two hops, said at least two hops comprising a proximate hop and a distant hop;
detecting a condition on said distant hop of said first path; and
switching said transmission to a second path of said virtual IP network.

17. The article as in claim 16, comprising instructions that when executed further result in evaluating an effect of said switching from said first path to said second path on said transmission of signals on said virtual IP network.

18. The article in claim 16, comprising instructions that when executed further result in evaluating an effect of said switch on an application running on said virtual IP network.

19. The article as in claim 16, comprising instructions that when executed further result in detecting a parameter selected from the group consisting of:
an event triggering said switching,
a time of said switching from said first route to said second route,
a speed of said switching from said first route to said second route,
a loss of communication signals upon said switching from said first route to said second route,
a sensitivity of said switching to said pre-defined criteria,
a throughput on said second route,
a utilization on said second route, and
a performance of an application on said IP network following said switching from said first route to said second route.

20. A system comprising:
a memory to store data about:
a first route on a virtual IP network,
a second route on said virtual IP network,
a pre-defined criteria for switching transmission of signals on said virtual IP network from said first route to said second route; and
a processor to test for a condition on said first route, said condition matching said pre-defined criteria, said condition selected from the group consisting of:
a failure over time, packet loss over time,
a link usage in over time for utilization,
a link usage in over time for throughput,
a link usage out over time for utilization,
a link usage out over time for throughput,
a number of packets,
a number of bytes,
a size of packets, and
a content of a packet.

21. The system as in claim 20, wherein said first route comprises a plurality of hops comprising a proximate hop and a distant hop; and wherein said processor is to generate said condition on said distant hop.

22. The system as in claim 20, wherein said processor is to determine a parameter selected from the group consisting of:
an event triggering said switching,
a time of said switching from said first route to said second route,
a speed of said switching from said first route to said second route,
a loss of communication signals upon said switching from said first route to said second route,
a sensitivity of said switching to said pre-defined criteria,
a throughput on said second route,
a utilization on said second route, and
a performance of an application on said IP network following said switching from said first route to said second route.

23. A method comprising:
designating a first path of a virtual IP network,
detecting a condition on said first path, said condition selected from the group consisting of:
a failure over time,
packet loss over time,
a link usage in over time for utilization,
a link usage in over time for throughput,
a link usage out over time for utilization,
a link usage out over time for throughput,
a number of packets,
a number of bytes,
a size of packets, and
a content of a packet; and
switching a transmission of signals over the IP network from said first path to a second path.

24. The method as in claim 23, wherein said first path comprises a plurality of hops, said plurality comprising a proximate hop and a distant hop; and wherein said processor to is evaluate said condition on said distant hop, said condition matching a pre-defined criteria.

25. The system as in claim 23, comprising determining a parameter selected from the group consisting of:
an event triggering said switching,
a time of said switching from said first route to said second route,
a speed of said switching from said first route to said second route,
a loss of communication signals upon said switching from said first route to said second route,
a sensitivity of said switching to said pre-defined criteria,
a throughput on said second route,
a utilization on said second route, and
a performance of an application on said IP network following said switching from said first route to said second route.

26. An article comprising instructions stored thereon that when executed result in:
designating a first path of a virtual IP network,
detecting a condition on said first path, said condition selected from the group consisting of:
a failure over time,
packet loss over time,
a link usage in over time for utilization,
a link usage in over time for throughput,
a link usage out over time for utilization,
a link usage out over time for throughput,
a number of packets,
a number of bytes,
a size of packets, and
a content of a packet; and
switching a transmission of signals over the IP network from the first path to the second path.

27. The article as in claim 26, wherein said first path comprises a plurality of hops, said plurality comprising a proximate hop and a distant hop; and having instructions that further result in evaluating said condition on said distant hop, said condition matching a pre-defined criteria.

28. The article as in claim 26, having instructions that result in calculating a parameter selected from the group consisting of:
an event triggering said switching,
a time of said switching from said first route to said second route,
a speed of said switching from said first route to said second route,
a loss of communication signals upon said switching from said first route to said second route,
a sensitivity of said switching to said pre-defined criteria,
a throughput on said second route,
a utilization on said second route, and
a performance of an application on said IP network following said switching from said first route to said second route.
